(19) United States
(12) Patent Application Publication
(10) Pub. No.: US 2011/0014106 A1
(43) Pub. Date: Jan. 20, 2011

(54) COMBUSTION FLUE GAS SOx TREATMENT VIA DRY SORBENT INJECTION

(75) Inventors: Henry A. Pfeffer, Mercerville, NJ (US); David E. Smith, Plainsboro, NJ (US); William C. Copenhafer, Yardley, PA (US); Ann Copenhafer, Yardley, PA (US)

Correspondence Address: PATENT ADMINISTRATOR;FMC CORPORATION, 1735 MARKET STREET, PHILADELPHIA, PA, 19103, US

(73) Assignee: FMC CORPORATION, Philadelphia, PA (US)

(21) Appl. No.: 12/834,999

(22) Filed: Jul. 13, 2010

Related U.S. Application Data
(60) Provisional application No. 61/225,593, filed on Jul. 15, 2009.

(51) Int. Cl. B01D 53/68

(52) U.S. Cl. 423/244.08; 423/244.07

(57) ABSTRACT

Combustion flue gas containing SO_{X} is treated to remove SO_{X} using a dry particulate sorbent injection procedure in which a sodium-based sorbent precursor is calcined immediately prior to its introduction into the flue gas stream, to activate the sorbent for reaction with SO_{X}. The sorbent precursor is a NaHCO₃-containing compound, and trona is preferred as the sorbent precursor.

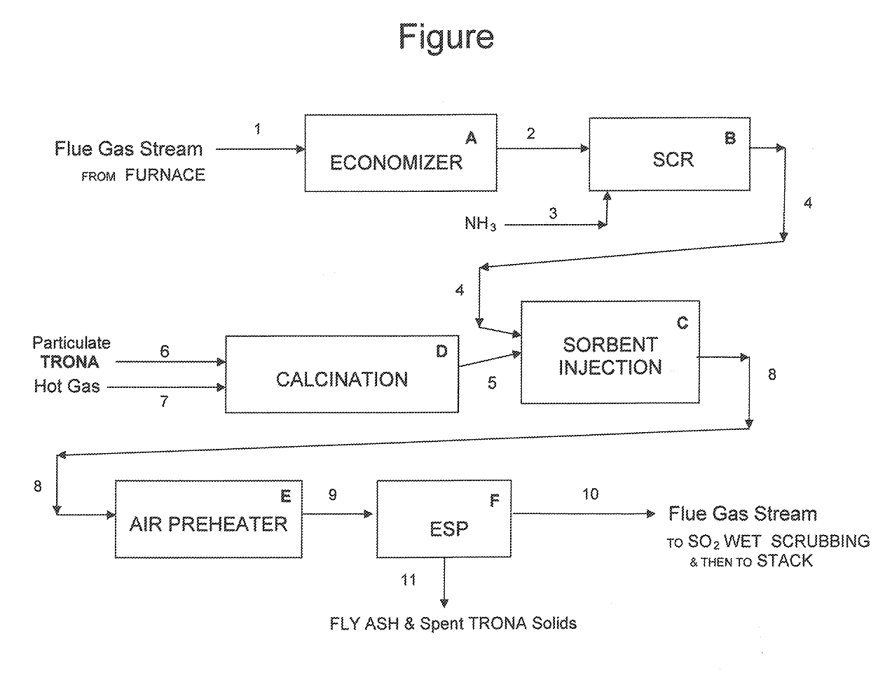

### FIELD OF THE INVENTION

The present invention relates air pollution control and more particularly to the treatment of a combustion flue gas stream from a stationary source to remove its SOₓ contaminants via injection of a dry sorbent before the gas stream is released into the atmosphere.

### BACKGROUND OF THE INVENTION

Combustion of fuels such as coal, coke, natural gas or oil typically results in the presence of pollutants in the combustion flue gas stream resulting from the combustion process or derived from impurities present in the fuel source. Electric utility power plants that burn coal which also contains sulfur are a major source of such combustion process air pollutants, but other stationary fuel-burning facilities such as industrial boilers, waste incinerators, manufacturing plants are also pollution sources.

The primary air pollutants formed by these stationary high temperature combustion sources are sulfur oxides (e.g., SO₂ and SO₃), also called SO_{X} gases, and nitrogen oxides, also called NO_{X} gases, both of which are acid gases. Other combustion pollutants of concern in these combustion flue gases include other acid gases such as HCl and HF, Hg, CO₂ and particulates. These individual pollutant components from stationary combustion sources have been subject to increasingly more stringent regulatory requirements over the past three decades, and emission standards are likely to be tightened in the future.

Sulfur dioxide, SO₂, is the predominant SO_{X} component in flue gas streams obtained from combustion of sulfur-containing fuels, with sulfur trioxide, SO₃, being produced in much smaller quantities than SO₂. These SO_{X} components of flue gases are well-known air pollutants, and desulfurization measures are often used to control or minimize the amounts of these gases in the flue gas streams that are released into the atmosphere.

Desulfurization methods for removing SO₂ and SO₃ are well known in the air pollution control field, and known flue gas desulfurization methods use calcium or sodium alkali sorbents, or combinations of these, in dry injection, semi-dry scrubbing or wet scrubbing operations. Currently preferred desulfurization methods for newly-constructed high-sulfur coal-fired power plants utilize wet scrubbing in gas-liquid contactors or absorbers that use limestone or lime as the SO₂-reactive desulfurization agent.

Retrofitting existing older small capacity power plants with desulfurization equipment is often limited by the lack of available room, a significant issue with the installation of wet scrubbing desulfurization equipment. Dry injection desulfurization techniques, however, have distinct advantages in treating SO_{X}-containing flue gas streams in existing power plants: operational simplicity and reliability; attractive equipment and labor costs; and lower water consumption, as compared with conventional wet desulfurization systems. Dry injection systems have equipment requirements that are normally modest, and equipment installation does not require major modification of process flow streams, important factors in retrofitting existing power plants with a desulfurization system.

Dry injection systems involve injection of a dry particulate sorbent, usually a calcium or sodium sorbent, into the flue gas stream to react with the SO_{X} component in the flue gas, with the sorbent being collected downstream (often along with fly ash) in a solids collection device such as baghouse filters or electrostatic precipitators. The reaction of SO_{X} with the sorbent occurs while the sorbent is suspended in the gas stream and also when flue gas passes through the collected solid, e.g., baghouse filter cake. The collected sorbent and fly ash solids mixture is periodically removed from the solids collection device for disposal.

Dry calcium sorbents such as lime (CaO) or hydrated lime (Ca(OH)₂) may require humidification via separate injection of atomized water droplets to activate the lime once it is injected into the flue duct, a disadvantage not shared with sodium-based sorbents. SO_{X} removal efficiencies with dry sodium sorbents are generally higher than those with calcium sorbents.

Dry injection desulfurization sorbents that are sodium-type compounds include nahcolite (naturally-occurring mineral form of sodium bicarbonate), soda ash (sodium carbonate) and trona (naturally-occurring mineral form of sodium sesquicarbonate).

Dry injection systems for flue gas desulfurization are described in the prior art, in both older and more recent patents.

U.S. Pat. No. 4,062,926 issued to Knight describes a dry injection process in which thermally crushed nahcolite, obtained by exposing particulate nahcolite to gas temperatures in excess of 1500° F. to create micron-sized nahcolite particles, is utilized for removing sulfur dioxide from such high temperature flue gas streams. U.S. Pat. No. 4,018,868 issued to Knight describes a related dry injection process in which the particulate nahcolite is thermally crushed, in a first step at gas temperatures in excess of 1500° F., before being used in a second step to remove sulfur dioxide, NO_{X}, etc. in flue gas at temperatures of up to 1500° F.

U.S. Pat. No. 4,481,172 issued to Lowell et al. describes a flue gas desulfurization process in which a flue gas stream is contacted with activated sodium carbonate sorbent in dry form, and the spent sorbent is thereafter regenerated. The activated sodium carbonate is obtained by calcination of sodium bicarbonate or trona at about 70° C. to about 200° C.

U.S. Pat. No. 4,555,391 issued to Cyran et al. describes a dry injection desulfurization process that uses a dry soda-type compound as the sorbent to desulfurize a SO₂-containing flue gas stream and recycles a portion of the spent sorbent to increase sorbent utilization efficiency. U.S. Pat. No. 4,588,569 issued to Cyran et al. describes a dry injection desulfurization process that uses a dry particulate soda ash sorbent to desulfurize a SO₂-containing flue gas stream at a temperature of 100° C. to about 175° C. The soda ash sorbent is a porous sodium carbonate obtained from calcination of a NaHCO₃-containing compound like sodium bicarbonate or sodium sesquicarbonate. U.S. Pat. No. 4,588,569 issued to Cyran et al. is hereby incorporated by reference for its disclosures about the calcination of sodium sesquicarbonate and other NaHCO₃-containing compounds and their use as SO₂-reactive sorbents.

U.S. Patent Publication No. 2005-0201914 of Ritzenthaler describes a dry injection process for removing acid gases, including sulfur trioxide and sulfuric acid, from flue gas streams using a dry sodium sorbent. The sodium sorbent may be sodium sesquicarbonate, sodium carbonate-bicarbonate or trona, which is injected into the flue gas stream and calcined to soda ash which reacts with the strong acid components in the flue gas.

U.S. Pat. No. 7,481,987 issued to Maziuk, Jr. describes a dry injection desulfurization process in which sulfur trioxide (SO₃) is removed from a flue gas stream, using a sorbent that is sodium sesquicarbonate or sodium bicarbonate or soda ash. U.S. Patent Publication No. 2007-0041885 of Maziuk, Jr. describes another dry injection desulfurization process in which sulfur dioxide (SO₂) is removed from a flue gas stream, using trona as the sorbent.

The present invention provides a dry injection system for desulfurization of SO_{X}-containing flue gas streams that provides improved sorbent utilization and desulfurization efficiencies.

### SUMMARY OF THE INVENTION

In accordance with the present invention, a combustion flue gas stream is desulfurized in a process which comprises (i) injecting a calcined particulate sodium-based sorbent having a mean particle size smaller than about 75 μm into a combustion flue gas stream containing SO_{X}, the flue gas stream having a temperature of about 200° F. to about 1100° F. to desulfurize the flue gas, the sorbent being derived from a sorbent precursor selected from the group consisting of trona, sodium sesquicarbonate, nahcolite, sodium bicarbonate, wegscheiderite and combinations of these, and the sorbent being prepared for injection and reaction with SO_{X} by subjecting the sorbent precursor, immediately prior to its injection into the flue gas stream, to a calcination step by calcining the sorbent precursor to decompose at least a portion of its sodium bicarbonate content and thereby activate the sorbent precursor for reaction with SO_{X}, and (ii) collecting the injected sorbent downstream of the injection point in a solids collection device.

Another embodiment of the present invention is a process for desulfurizing a combustion flue gas stream which comprises (i) injecting a calcined particulate sodium-based sorbent into a combustion flue gas stream containing SO_{X}, the flue gas stream having a temperature of about 200° F. to about 1100° F., to desulfurize the flue gas, the sorbent being derived from a sorbent precursor selected from the group consisting of trona, sodium sesquicarbonate, nahcolite, sodium bicarbonate, wegscheiderite and combinations of these, and the sorbent being prepared for injection and reaction with SO_{X} by milling a coarsely-sized sorbent precursor to provide a milled particulate sorbent precursor having a mean particle size smaller than about 75 μm and by subjecting the milled sorbent precursor, immediately prior to its injection into the flue gas stream, to a calcination step by calcining the sorbent precursor to decompose at least a portion of its sodium bicarbonate content and thereby activate the sorbent precursor for reaction with SO_{X}, and (ii) collecting the injected sorbent downstream of the injection point in a solids collection device.

### BRIEF SUMMARY OF THE DRAWING

The FIGURE is a schematic flow diagram illustrating a preferred embodiment of the combustion flue gas SO_{X} treatment process of this invention that is described in the Example.

### DETAILED DESCRIPTION OF THE INVENTION

The present invention is directed to improved SO_{X} treatment processes that use dry sorbent injection for flue gas desulfurization, particularly dry sorbents comprising NaHCO₃-containing compounds. The invention is particularly well suited for treatment of SO_{X}-contaminated flue gas streams from stationary combustion sources, e.g., electric utility coal-fired power plants.

In the present invention, the dry sorbent is subjected to a calcination step immediately prior to its injection into the flue gas stream where it reacts with the SO_{X} components in the flue gas. The calcination serves to initiate activation of the sorbent, by decomposing the NaHCO₃ in the sorbent.

The sorbent calcination step, being carried out externally to the flue gas stream environment, can be precisely controlled to provide the optimal reactivity characteristics desired for the sorbent's reaction with the SO_{X} components in the flue gas stream. The traditional approach of direct injection of the dry uncalcined sorbent into the flue gas stream to effect not only calcination of the sorbent but also its reaction with the SO_{X} is limited by use of the flue gas temperature at the sorbent injection point, which may or may not provide optimal sorbent calcination conditions for obtaining a highly active (reactive) sorbent.

A related advantage of the sorbent calcination step of this invention is a reduction in reaction residence time required. The sorbent calcination functions to initiate activation of the dry sorbent and make the sorbent immediately available for reaction with SO_{X} components in the gas stream once it is injected into the flue gas stream. The sorbent, when introduced into the flue gas stream, no longer requires additional residence time for its calcination to become fully activated for reaction with the SO_{X} components in the flue gas.

In addition, the calcination step can improve the utilization efficiency of the sorbent, which is activated by the calcination step prior to the sorbent's injection and which is therefore more immediately available to react with SO_{X} in the flue gas upon its injection into the flue gas stream.

The advantages associated with the sorbent pre-injection calcination step just described also favor the dry injection process of this invention in the desulfurization treatment of lower temperature flue gas streams. The dry sorbent of this invention is activated prior to its injection into the SO_{X}-containing flue gas stream, so high flue gas temperatures are not needed to ensure sorbent calcination, i.e., activation, which is required for the sorbent's efficient reaction with the SO_{X} in the flue gas stream being treated.

### Combustion Flue Gas Stream

The combustion flue gas stream exiting the combustion zone of a stationary source contains a variety of components that are desirably reduced or removed from the flue gas prior to its being discharged to the atmosphere, among which are the SO_{X} components treated according to the present invention. The precise composition of the combustion flue gas depends primarily on the nature of the fuel and on the furnace design and operating parameters. For example, the fuel may be, e.g., coal, oil, coke or natural gas, etc., and in the case of coal, coal may be high sulfur or low sulfur, bituminous or anthracite, etc.

A representative flue gas stream obtained from combustion of high sulfur coal containing 2.5 wt % sulfur, burned using 10% excess air, has the composition shown in Table 1.

TABLE 1
Flue Gas Composition

| Component | Concentration: volume basis |
|---|---|
| SO₂ | 0.22% |
| SO₃ | 20 parts per million (ppm) |
| NO | 400 ppm |
| NO₂ | 60 ppm |
| H₂O | 9% |
| CO₂ | 15% |
| Hg | 1 part per billion (ppb) |
| Other Gases | 76% |

The SO₂ concentration in the flue gas stream is relatively high, as would be expected from the burning of high sulfur coal. The SO₃ concentration is typically only about 1% of the SO₂ concentration. The NO concentration in the flue gas stream is typical of that expected from the burning of high sulfur coal in a furnace that is not equipped with low NO_{X} burners. The NO₂ concentration typically represents about 5% or less of the total NO_{X} concentration.

The foregoing flue gas composition is simply meant to be illustrative of a typical combustion flue gas stream. The present invention is adapted to be used for dry sorbent injection desulfurization of a wide range of different SO_{X}-containing flue gas compositions, within the parameters described in more detail below.

The SO_{X} in combustion flue gas streams is primarily sulfur dioxide (SO₂) and sulfur trioxide (SO₃). These SO_{X} components are normally formed during the combustion of sulfur-containing (sour) fuels, such as coal, coke or oil, and the flue gas streams that result from burning such sulfur-containing fuels, whether low-sulfur or high sulfur, consequently contain SO_{X} contaminants.

Sulfur dioxide is the predominant SO_{X} component in flue gas streams, with sulfur trioxide, SO₃, being produced in much smaller quantities than SO₂. Concentrations of SO₂ in flue gas streams from coal fired boilers are typically substantial, e.g., about 0.01 vol % to about 0.5 vol % SO₂, with about 0.05 vol % to about 0.3 vol % SO₂ being typical. The dry injection process of this invention may be employed to remove these broad ranges of SO₂ in contaminated flue gas streams containing the same.

Typical concentrations of SO₃ in flue gas streams from coal fired boilers are about 10 ppm to about 30 ppm (by volume) SO₃. Pollution control operations to remove NO_{X} components from the flue gas stream, e.g., via selective catalytic reduction (SCR), often result in an unwanted increased concentration of SO₃, formed by the catalytic oxidation of SO₂ in the flue gas stream during SCR treatment, to levels that can double those normally present, e.g., to about 20 to about 60 ppm or more SO₃. Likewise, the presence of catalytic metals, e.g., vanadium or nickel, in some fuels can also result in the generation of additional sulfur trioxide. The dry injection process of this invention is especially useful for treating SO₃-contaminated flue gas streams containing these broad concentration ranges of SO₃.

The desulfurization process of the present invention is applicable to dry-injected calcined sorbents that are used to remove SO_{X} components from flue gas streams, e.g., including both SO₂ and SO₃. The dry-injected calcined sorbents of this invention may also be useful for removal of other acid gases besides SO_{X} components from flue gas streams, e.g., HCl and HF, and are also reactive with NO_{X} components in flue gas streams. The removal of these other flue gas stream components may be carried out concurrently with SO_{X} removal or as a separate step.

### Sorbent & Sorbent Precursors

The calcined sorbent material of this invention is a dry solid that is characterized by its capability, when injected into, or introduced into, or otherwise contacted with an SO_{X}-containing flue gas stream, to react or otherwise combine with SO₂ and/or SO₃ and/or other sulfur components (e.g., H₂SO₄) present in the flue gas stream to effect removal of such SO_{X} components from the flue gas stream.

The dry injection sorbent is obtained from calcination of a precursor compound, which may be any of several known alkali compounds but is preferably a sodium-based compound. The calcined sorbent of this invention is preferably a sodium sorbent whose precursor contains NaHCO₃ and, optionally, Na₂CO₃.

Preferred sorbent precursor compounds (i.e., prior to calcination) for use in the present invention are sodium-based reagents containing NaHCO₃ and those containing NaHCO₃ in combination with Na₂CO₃. Such sodium-based or soda-type alkali reagents include NaHCO₃-containing materials such as trona (a natural mineral containing Na₂CO₃.NaHCO₃.2H₂O), sodium sesquicarbonate (refined or re-crystallized trona, Na₂CO₃.NaHCO₃.2H₂O), nahcolite (a natural mineral containing NaHCO₃), sodium bicarbonate (NaHCO₃), and wegscheiderite (a natural mineral containing Na₂CO₃.3NaHCO₃).

Trona, sodium sesquicarbonate, nahcolite and sodium bicarbonate are preferred for use as the precursor compound that is used to prepare the calcined sorbent in the present invention, since such calcined sorbents exhibit very good SO_{X} removal efficacy and are economical calcined dry sorbents.

It should also be understood that the naturally-occurring forms of NaHCO₃-containing compounds used as sorbent precursors, e.g., trona, nahcolite or wegscheiderite, are crude materials that typically have other mineral or inorganic components, that are present in normally minor amounts and are typically water-insoluble. Such additional components are sometimes referred to as insolubles and normally have no significant adverse impact on the SO_{X}-removal efficacy of such calcined sorbents in the process of this invention.

### Sorbent Particle Sizing

The calcined sorbent of this invention is injected or otherwise introduced in dry form, as a particulate solid into the SO_{X}-containing flue gas stream. The calcined sorbent is preferably utilized as a particulate solid in finely-divided form, most preferably as extremely fine particles. The calcination step of this invention typically has little significant impact on the calcined sorbent particle sizing as compared with its uncalcined precursor, so the discussion about particle sizing which follows is also applicable to the uncalcined precursor compound.

The particulate alkali sorbent should have a relatively small particle size in order to maximize the surface-to-volume ratio, i.e., thereby enhancing the effectiveness of the gas-solid interaction between the SO_{X} and dry particulate calcined sorbent. In the case of natural mineral sorbent precursors such as trona and nahcolite, the small particle size has the additional advantage of reducing the potential blinding or blocking effect of any insolubles that may also be present in the mineral along with the sodium-containing sorbent precursor (e.g., sodium sesquicarbonate or sodium bicarbonate), which may possibly otherwise interfere with access of the SO_{X} to the calcined sodium-based sorbent.

The mean particle size of the sodium-based particulate sorbent should be less than about 100 μm. The mean particle size of the sodium-based sorbent is preferably less than about 75 μm, more preferably less than about 50 μm, and most preferably less than about 40 μm. In addition, substantially all (90% or more, by volume) of the particles are preferably less than about 70 μm and, more preferably, less than about 50 μm.

Sorbent precursor compounds suitable for use in the present invention are commercially available, e.g., EnProve™ milled trona available from FMC Corporation (Philadelphia, Pa.) and SOLVAir® Select 200 trona from Solvay Chemicals, Inc. (Houston, Tex.).

### Optional Milling

An optional step prior to the sorbent precursor calcination of the present invention is the on-site milling of the dry sorbent to achieve the desired fine particle sizing sought for the dry sorbent. This milling step is particularly useful if the available sorbent precursor does not possess the fine particle sizing that is preferable for use in the present invention and permits more precise control of the particle sizing of the calcined sorbent. This optional milling step, like the calcination step, is carried out at the site of its use for flue gas desulfurization and, preferably, prior to its being subjected to the calcination step.

Conventional grinding or milling equipment can be employed to achieve the preferred sorbent particle size objectives, in the optional milling step of this invention. The milling of the dry sorbent may be carried out using conventional solids milling equipment such as hammer mills, impact mills, ball mills, pin mills or the like, typically in combination with a solids (particle size) air classifier. Pin mills have the advantage of producing a finer-sized particle.

The coarsely-sized sorbent precursor material subjected to the optional milling step typically has a mean particle size greater than about 75 μm and more typically greater than about 100 μm. In some situations, the sorbent precursor material subjected to the optional milling step may have a mean particle size as low as about 50 μm, where an extremely fine milled particulate sorbent precursor is desired, e.g., having less than about 40 μm mean particle size. The terms coarse and coarsely-sized in reference to the sorbent precursor are used in this specification to describe a mean particle size of at least about 50 μm and, and more preferably, at least about 75 μm, prior to the milling step of this invention being carried out on such coarse or coarsely-sized sorbent precursor material.

The coarsely-sized sorbent precursor employed in this optional milling step preferably has a mean particle size of no more than about 10 mm and more preferably no more than about 1 mm. Extremely coarse sorbent precursor material, e.g., corresponding to pebble-size or cobble-size or larger, could be utilized but normally would require an initial crushing and sizing step or a multi-step milling and sizing procedure.

The optional milling step is preferably carried out by milling and sizing the coarsely-sized sorbent precursor to provide a milled and sized particulate sorbent precursor having a mean particle size smaller than about 75 μm and by subjecting the milled sorbent precursor, immediately prior to its injection into the flue gas stream, to the calcination step of this invention to decompose at least a portion of its sodium bicarbonate content and thereby activate the sorbent precursor for reaction with SO_{X}.

Alternatively, the optional milling step may be carried out by first calcining a coarsely-sized sorbent precursor according to the calcination step of this invention, e.g., in a fluid bed calciner, and thereafter milling the calcined sorbent in-line, prior to its injection into the flue gas stream, to provide a milled particulate calcined sorbent having a mean particle size smaller than about 75 μm.

The optional on-site milling step of the present invention provides an advantage over finely-sized sorbent precursor milled off-site, since the finely-sized sorbent precursor of this invention can be introduced directly to a calcination step after being milled in the optional milling step, without intermediate medium- or long-term storage. Sorbent precursor material that is milled off-site to an extremely fine particle size and then introduced into a storage or holding container can settle, compact or compress to the point where the milled material does not flow readily and can be a challenge to remove from solids transport carriers (dry bulk railcars or road trailers) or from storage facilities (storage silos or hoppers).

### Sorbent Precursor Calcination

An essential aspect of the present invention is the calcination of the NaHCO₃ -containing sorbent precursor immediately prior to the sorbent being injected or otherwise introduced as a dry particulate solid into the SO_{X}-containing flue gas stream. The calcination of the sorbent precursor in this invention is carried out externally to the flue gas stream, so that more precise and more optimized control of the calcination temperature, residence time and other parameters are achieved than if the sorbent precursor were to be injected directly into the hot flue gas stream and calcined therein, concurrently with SO_{X} removal.

The calcination step serves to activate the sorbent precursor, by decomposing at least a significant portion of its sodium bicarbonate (NaHCO₃) content and increasing the available surface area and porosity in the resulting calcined sorbent. Such increased surface area and porosity of the calcined sorbent is believed to allow the sodium carbonate content of the calcined sorbent to react more readily and efficiently with the SO_{X} and other contaminants in the flue gas stream being treated, when the calcined sorbent in injected into the flue gas stream.

In the present invention, the calcination is carried out to provide substantial calcination of the sorbent precursor, before its injection into the flue gas stream. The calcination of the sorbent precursor should effect decomposition of at least about 25 wt % of the sodium bicarbonate content in the sorbent precursor. Preferably, the calcination decomposes at least about 50 wt % of the sodium bicarbonate content in the sorbent precursor. More preferably, the calcination decomposes at least about 80 wt % of the sodium bicarbonate content in the sorbent precursor.

In the most preferred embodiment of this invention, the calcination step is preferably carried out in a manner that decomposes substantially all of the sodium bicarbonate content in the sorbent precursor, leaving less than about 10% residual undecomposed sodium bicarbonate (based on the amount initially present in the precursor) in the calcined sorbent. Such highly calcined sorbent is essentially fully activated for reaction with SO_{X} when injected or otherwise introduced into the flue gas stream.

It is believed that further activation of the calcined sorbent may continue to occur in the hot flue gas stream once the calcined sorbent is injected into the SO_{X}-containing flue gas stream, with the extent of further decomposition of the calcined sorbent's remaining NaHCO₃ content depending on the flue gas temperature and sorbent residence time in the gas stream. Such additional, further calcination in the flue gas stream is believed to enhance the reactivity of the calcined sorbent via the creation of newly-created surface area, available for further reaction with SO_{X} in the flue gas stream.

In the case of trona or sodium sesquicarbonate as the sorbent precursor, the calcination also effects removal of the waters of hydration (in the Na₂CO₃.NaHCO₃.2H₂O), in addition to decomposition of the NaHCO₃ content of the sorbent precursor. The removal of the waters of hydration plus the decomposition of the NaHCO₃ content of the sorbent precursor provides enhanced porosity and surface area available for reaction with SO_{X} in the SO_{X}-containing flue gas stream. The calcination step of this invention is believed to proceed by first removing the hydrated water and then decomposing sodium bicarbonate in a NaHCO₃-containing sorbent precursor that contains sodium sesquicarbonate, e.g., trona.

The flue gas treatment process of this invention is normally carried out on a continuous basis, with a flow stream of the sorbent precursor compound being calcined continuous and externally to the flue gas stream and then being introduced continuously into the flue gas stream, e.g., by injection, for reaction with SO_{X} in the flue gas stream. Semi-continuous or intermittent operation is also possible for carrying out the process of this invention.

It should be recognized that storage or holding facilities may be employed, for temporary or short term holding of the calcined sorbent prior to its introduction into the flue gas stream, e.g., in cases of system upsets or downtimes such as for maintenance affecting the sorbent calcination system. The provision and use of such in line holding or inventory storage apparatus is within the scope of this invention.

The calcined sorbent may be injected continuously or semi-continuously as a dry particulate solid into the SO_{X}-containing flue gas stream using conventional solids injection equipment, e.g., a screw conveyor, rotary lock valve with blower or other pneumatic injection device.

### Calcination Techniques & Temperature

The sorbent precursor calcination is typically carried out by heating the particulate sorbent precursor to a temperature in the range of about 175° F. to about 500° F. The calcination step preferably heats the sorbent precursor to a temperature of about 200° F. to about 400° F. It is important to recognize that the sorbent calcination temperature represents the temperature of the sorbent, which is not necessarily the temperature of the heating medium used to calcine the sorbent precursor.

The heating medium used to calcine the sorbent precursor is preferably a hot gas, e.g., a hot gas stream, where the particulate sorbent is heated by direct contact with a hot gas or hot gas stream. The hot gas stream in the calcination step preferably comprises combustion gas from burning of natural gas.

Alternatively, or in addition, the hot gas stream in the calcination step may comprise a side stream of combustion flue gas, withdrawn from the flue gas stream, e.g., upstream or even downstream of the sorbent injection point, before the flue gas stream has been cooled significantly. Examples of suitable flue gas side streams include combustion flue gas that is diverted from the hot-side or cool-side of an economizer or diverted from the hot-side of an air preheater. Gas diverted from the hot-side of an economizer is preferred, as a diverted gas stream diverted from the upstream flue gas stream for use in calcination, since its temperature is typically on the order of 1000° F.

In the case where the calcination apparatus is a fluid bed dryer, the temperature of the calcined sorbent and the hot gas will likely become equilibrated, e.g., at a temperature of about 200° F. to about 300° F. or higher, but less than about 500° F. By contrast, calcination of the sorbent precursor with hot gas in a flash dryer apparatus, e.g., using gas having a temperature up to about 1500-1600° F., will heat the calcined sorbent, but the calcined sorbent is maintained in contact with the heating medium gas for a time sufficient to control heating of the calcined sorbent to a temperature within the range of about 175° F. to about 500° F.

It is also possible that the calcination of the sorbent precursor could be carried out indirectly, e.g., using a hot gas or other heating medium to heat the particulate sorbent precursor indirectly (not in direct contact) to a temperature sufficient to effect sorbent calcination and activation.

### Calcination Reactions

The sorbent precursor calcination effects activation of the NaHCO₃-containing sorbent precursor, in which at least a portion of the sodium bicarbonate content of the sorbent precursor is believed to undergo reaction by the following simplified reaction path:

2NaHCO₃→Na₂CO₃+CO₂↑+H₂O↑ (1)

The sodium carbonate formed by decomposition of the sodium bicarbonate during calcination is a solid product, and the carbon dioxide and water also formed during decomposition are gaseous. The formation of these gaseous reaction products during decomposition or conversion of the bicarbonate to carbonate in the NaHCO₃-containing sorbent precursor in the calcination step is believed to create additional surface area, voids and porosity within the calcined particulate sorbent. This additional surface area, void space and porosity formed during calcination appear to promote more efficient reaction of the sorbent's sodium content with the targeted SO_{X} in the flue gas stream.

In the case of trona or sodium sesquicarbonate being used as the sorbent precursor, the calcination step also effects removal of the water of hydration in the sodium sesquicarbonate, which is believed to occur by the following simplified reaction path:

Na₂CO₃.NaHCO₃.2H₂O→Na₂CO₃+NaHCO₃+2H₂O↑ (2)

Calcination of trona or sodium sesquicarbonate also results in the decomposition of sodium bicarbonate, as shown in reaction (1) above.

The water of hydration is released as water vapor during the calcination step, as shown in reaction (2). Analogous to the bicarbonate-to-carbonate conversion mentioned above, removal of the hydrated water from trona in the calcination step is believed to create additional surface area and voids within the calcined particulate sorbent that promote more efficient reaction of the sodium content of the sorbent with SO_{X} in the flue gas stream.

### Calcination Step Advantages

The on-site sorbent precursor calcination step of this invention avoids handling and storage problems associated with sorbent that is calcined long before its use in flue gas desulfurization and then stored in silos, hoppers or other dry solids holding facilities or transported to the desulfurization site. Calcined sorbent, as compared with similar-sized uncalcined sorbent, can be more friable and may be subject to crushing and breakage, making calcined sorbent vulnerable to loss of available surface area and/or porosity, factors that adversely affect sorbent reactivity. The dry sorbent desulfurization process of this invention has a distinct advantage over prior art sorbent calcination techniques, since the present invention avoids the likelihood that the calcined sorbent will be subject to settling and compression that occurs during transport in solids bulk carriers and/or storage in solids holding facilities.

A further advantage of the process of this invention is that the calcined sorbent is injected or introduced into the flue gas stream being treated, immediately after calcination of the sorbent precursor. This aspect of the present invention minimizes the possibility that the calcined sorbent may be exposed to water vapor over an extended period of time (e.g., during transport or storage), a factor that can lead to loss of reactivity in the calcined sorbent because of water vapor-induced enlargement of pore sizes in the calcined sorbent and blockage of available reactive surface area in the calcined sorbent.

### Desulfurization Operation—Temperature and Injection Procedure

The desulfurization process of this invention is carried out by injecting the calcined sorbent into the SO_{X}-containing flue gas stream. The calcined sorbent is normally injected into the SO_{X}-containing flue gas stream being treated upstream of the point where solids collection devices are located.

The terms injection and injecting, as used in this specification, are intended to encompass other means of introducing or otherwise contacting the calcined sorbent with the flue gas stream to be treated. For example, the calcined sorbent may be contacted with the flue gas stream by loading or introducing the sorbent onto the fabric bags of a bag filtration solids collection device through which the flue gas stream passes, such that the calcined sorbent is in contact with the SO_{X}-containing flue gas stream during the bag filtration collection cycle.

The calcined sorbent is injected into the SO_{X}-containing flue gas stream, which is at a temperature sufficient to provide further activation of the sorbent as needed, and reaction of the sorbent with the SO_{X} component being targeted for removal.

The temperature of the flue gas stream at the sorbent injection point is normally within the range of about 200° F. to about 1100° F. and, more preferably, is about 250° F. to about 900° F. These flue gas stream temperatures promote efficient reaction of the injected calcined sorbent with SO_{X} in the flue gas stream, to remove at least a portion of the SO_{X} from the flue gas by the solid sorbent's reaction with the SO_{X} in the flue gas stream.

Factors that affect the calcined sorbent SO_{X} removal efficiency include not only flue gas temperature but also residence time, sorbent sizing, sorbent injection rate and/or amount, sorbent-flue gas mixing, and flue gas SO_{X} concentration.

The calcined sorbent is injected as a dry particulate solid into the SO_{X}-containing flue gas stream using conventional solids injection equipment, e.g., a screw conveyor, rotary lock valve with blower or other pneumatic injection device, with the proviso that uniform dispersal of the calcined dry sorbent throughout the flue gas stream (or uniform contact of the sorbent with the bulk of the gas stream) is desired, to ensure efficient interaction between the sorbent and the SO_{X} in the flue gas stream.

### Desulfurization Reactions

The injected calcined sorbent reacts with SO_{X} in the flue gas stream in a desulfurization operation that removes at least a portion of the SO_{X} from the flue gas by the solid sorbent's reaction with the SO_{X} in the flue gas stream.

Among the desulfurization reactions that are believed to occur are the following, between the Na-containing sorbent and SO₂ and/or SO₃ present in the gas stream.

Na₂CO₃+SO₂→Na₂SO₃+CO₂ (3)

Na₂CO₃+SO₃→Na₂SO₄+CO₂ (4)

The reaction of the sorbent favors reaction with SO₃ in a flue gas containing both SO₃ and SO₂. Since SO₃ is normally present in relatively small amounts, e.g. 10-50 ppm SO₃, as compared with the flue gas SO₂ concentration, an excess of sorbent with respect to the SO₃ content of the flue gas will also be available to react with some of the SO₂ present or with other flue gas contaminants.

The sodium sulfite (Na₂SO₃) formed by the reaction of SO₂ with sodium carbonate can react further with oxygen in the flue gas stream, to form sodium sulfate (Na₂SO₄), as follows:

Na₂SO₃+½ O₂→Na₂SO₄ (5)

The sodium sulfite and sodium sulfate reaction products formed by the reaction of SO_{X} with sodium carbonate are solids and normally remain entrained in the flowing flue gas stream.

The entrained solids in the flue gas stream, following the sorbent injection, normally include sodium sulfite and sodium sulfate reaction products and unreacted or partially reacted sorbent. In addition, the flue gas stream may also contain fly ash and other combustion byproduct solids from the fuel combustion upstream, if the fly ash has not previously been removed.

All of these entrained solids in the flue gas stream may be captured downstream using the solids recovery equipment normally used in a flue gas pollution control system. Such solids-collection devices include conventional electrostatic precipitators or baghouse filters, typically used to remove fly ash and other solids from a flue gas stream. Alternatively, a wet scrubbing apparatus could be used to collect the spent sorbent in the treated flue gas stream.

In the event that the dry injection process of the present invention is employed only for SO₃ removal, then another desulfurization unit operation will be required for removal of the SO_{X} not being targeted for removal with the calcined sorbent. Such other desulfurization operation may occur either upstream or downstream of the point at which the calcined sorbent is injected into the flue gas stream in the process of this invention. For example, where the dry injection process of this invention is utilized specifically for SO₃ removal, a downstream SO₂ removal operation could utilize known desulfurization procedures such as wet scrubbing with an alkali.

### Desulfurization Residence Time

Residence time required for the injected sorbent to be in contact with the So_{X}-containing flue gas stream is normally very short, since the sorbent is already activated via the calcination step. Residence times of a fraction of a second up to about 2 to about 3 seconds are normally sufficient.

### Sorbent Amount for Desulfurization

The amount of calcined sorbent introduced into and contacted with the flue gas stream desirably provides at least a stoichiometric amount of Na with respect to the amount of SO_{X} in the flue gas stream that is being targeted for removal, e.g., SO₂ or SO₃ or both. As noted in reactions (3) and (4) above, two moles of sodium are required for stoichiometric reaction with one mole of either SO₂ or SO₃. It should be noted that the amounts of calcined sorbent referred to in this specification are based on the amount of SO_{X} targeted to be removed: if the flue gas stream contains 30 ppm SO₃ and 50% is targeted for removal, then the stoichiometric amount of calcined sorbent utilized is based on the sodium required to remove 15 ppm SO₃ (i.e., 50% of 30 ppm).

The amount of injected dry sorbent preferably provides at least about two moles of sodium (Na) based on the amount of targeted SO_{X} to be removed from the flue gas stream. The amount of injected dry sorbent employed may provide a significant stoichiometric excess, up to about twelve moles of sodium (Na) based on the amount of targeted SO_{X} to be removed from the flue gas stream.

### Sorbent SO_{X} Removal Efficiencies

The process of this invention provides excellent SO_{X} removal efficiencies, particularly using the preferred operating parameters described above. Generally, if at least a stoichiometric amount of sorbent is adequately mixed with the SO_{X}-containing flue gas at the desired temperature and is given an adequate residence time, then satisfactory SO_{X} targeted removal efficiencies will be achieved.

Calcined sorbent introduced into a SO₃-containing flue gas stream in at least a stoichiometric amount of sodium-based sorbent can remove at least about 30% of the SO₃ targeted for removal from the flue gas stream and can remove at least about 60%, or more, of the SO₃ targeted for removal from the flue gas stream, under preferred operating conditions. Most preferably, the calcined sorbent treatment removes at least about 80% of the SO₃ targeted for removal from the flue gas stream.

Similar removal efficiencies are also possible when the SO_{X}-containing flue gas stream is being treated to remove SO₂. It should be recognized, however, that (i) the calcined sorbent will react preferentially with SO₃ in a flue gas stream containing both SO₃ and SO₂ and (ii) SO₂ concentrations in flue gas steams are typically very high, as noted earlier, requiring substantial amounts of calcined sorbent for high SO₂ removal rates.

The following non-limiting Example illustrates a preferred embodiment of the present invention.

### EXAMPLE

The Example illustrates the application of a preferred embodiment of the present invention to the SO_{X} treatment of a flue gas stream from a combustion boiler utilizing high sulfur coal. The process is operated continuously, and normal steady state conditions are assumed for purposes of the Example. The FIGURE illustrates a schematic flow diagram of this preferred embodiment; reference numerals and letters in the FIGURE are included in the process description which follows. References to gaseous component concentrations in percentage (%), parts per million (ppm) or parts per billion (ppb) refer to such concentrations on a volume basis.

The coal used in the combustion unit of this Example is high sulfur coal containing 2 wt % sulfur. The combustion furnace is operated with preheated air, and it is assumed that there is 1% conversion of the sulfur in the coal to SO₃ in flue gas from the combustion unit. The exit combustion flue gas stream 1 contains about 900 parts per million (ppm) SO₂, about 9 ppm SO₃ and about 420 ppm NO_{R}.

Referring now to the FIGURE, the combustion flue gas stream 1 is passed through an economizer A, a gas-liquid heat exchange unit that reduces the temperature of the hot combustion flue gas stream 1 from about 900° F. to about 700° F. The cooling medium is water (not shown in the FIGURE) which is heated in the economizer A prior to its being directed to the boiler associated with the combustion furnace.

The cooled flue gas stream 2 from the economizer A has essentially the same composition as flue gas stream 1 and is then treated in a selective catalytic reduction reactor A to reduce its NO_{R} content. This selective catalytic reduction (SCR) unit operation reacts ammonia 3 with NO_{R} contained in the flue gas stream 2 as the flue gas stream passes through the catalyst bed in the SCR reactor B. The ammonia 3 is employed in an amount that provides a stoichiometric amount required to react with the NO_{R} that is contained in the flue gas stream 2.

The catalytic reduction reaction of NO_{R} in the SCR reactor B reduces the NO content of the flue gas stream, producing N₂ and water. The catalytic reaction also increases the SO₃ content of the SCR-treated flue gas by conversion of a small amount of SO₂ to SO₃.

The flue gas stream 4 exiting from the SCR unit operation B contains about 890 ppm SO₂ and about 18 ppm SO₃ and reduced levels of NO_{R}, about 50 ppm NO_{R}. The flue gas stream 4 also contains residual unreacted ammonia, in an amount of less than about 3 ppm NH₃.

The flue gas stream 4 from the SCR unit operation B and is next subjected to a dry sorbent injection treatment, shown as operation C in the FIGURE, to reduce the SO₃ content of the flue gas stream 4. The dry sorbent 5 is calcined particulate trona, in the form of a finely-milled powder having a mean particle size less than about 40 μm, with essentially all particles (90% by volume) being less than 50 μm.

Trona, a natural mineral containing Na₂CO₃.NaHCO₃.2 H₂O, is subjected to a calcination step, shown as operation D in the FIGURE. Particulate trona 6 is contacted with hot gas 7, obtained from combustion of natural gas with air (not shown in the FIGURE), to heat the trona to a temperature of about 300° F. to about 400° F. This calcination step not only removes the hydrated water from the trona and but also decomposes at least about 80 wt % of the initial sodium bicarbonate in the trona, to provide an activated sorbent 5.

The calcined trona sorbent 5 is conveyed from the calcination step D and is next injected into the SO₃-containing flue gas stream 4 in the sorbent injection operation C, for reaction with SO₃ in the flue gas stream 4. Calcined trona sorbent 5 is introduced into the flue gas stream 4 in an amount of about 2-times stoichiometric, based on the sodium content of the injected sorbent needed for reaction with the SO₃ (18 ppm) present in the flue gas stream.

The flue gas stream 4 from the SCR treatment has a temperature of about 700° F. when it is contacted with the injected calcined trona sorbent in the sorbent injection operation C. The residence time of the injected sorbent in contact with the flue gas stream is about one-two seconds, i.e., before the entrained sorbent solids are collected downstream in an electrostatic precipitator F, described below.

The treated flue gas stream 8, downstream of the sorbent injection operation C, contains a reduced level of SO₃, less than about 5 ppm SO₃, from the reaction of the SO₃ in the flue gas stream 8 with the injected calcined trona sorbent 5.

The sorbent-treated flue gas stream 8 downstream of the sorbent injection operation C is next passed through an air preheater E, a gas-gas heat exchange unit that reduces the temperature of the flue gas stream 8 from about 700° F. to about 330° F. in the exit gas stream 9. The cooling medium in the air preheater E is air (not shown in the FIGURE) which is heated in the air preheater E prior to its being directed to the combustion furnace to burn the coal.

The flue gas stream 9 exiting from the air preheater E is directed to one or more electrostatic precipitators (ESP), shown as block F labeled as ESP in the FIGURE, to remove entrained solids, i.e., reacted calcined trona solids, from the flue gas stream 9. The entrained solids in the flue gas stream 9 include fly ash from the coal combustion and spent calcined trona sorbent after its reaction with SO₃ and NO_{X} in the flue gas stream. The solids-free ESP-treated flue gas exits the electrostatic precipitator operation F as flue gas stream 10. The ESP solids, removed as stream 11, are disposed of in a landfill.

The ESP-treated flue gas stream 10, has a reduced, low SO₃ concentration, as compared with the upstream combustion flue gas stream 4 exiting the SCR reactor B: the flue gas stream 10 downstream of the ESP operation F contains less than about 5 ppm SO₃ vs. about 18 ppm SO₃ in upstream flue gas stream 4 exiting the SCR operation B.

The SO_{X}-containing flue gas stream 10 is typically subjected to a desulfurization procedure (not shown in the FIGURE) to reduce its SO₂ content before the flue gas stream is vented to the atmosphere. Wet desulfurization scrubbing operations using an alkali such as lime, limestone or soda ash, are well known procedures for desulfurizing SO_{X}-containing flue gas streams.

It will be appreciated by those skilled in the art that changes could be made to the embodiments described above without departing from the broad inventive concept thereof. It is understood, therefore, that this invention is not limited to the particular embodiments disclosed but is intended to cover modifications within the spirit and scope of the present invention as defined by the appended claims.

What is claimed is:

1. A process for desulfurizing a combustion flue gas stream which comprises (i) injecting a calcined particulate sodium-based sorbent having a mean particle size smaller than about 75 μm into a combustion flue gas stream containing SO_{X}, the flue gas stream having a temperature of about 200° F. to about 1100° F., to desulfurize the flue gas,
the sorbent being derived from a sorbent precursor selected from the group consisting of trona, sodium sesquicarbonate, nahcolite, sodium bicarbonate, wegscheiderite and combinations of these, and
the sorbent being prepared for injection and reaction with SO_{X} by subjecting the sorbent precursor, immediately prior to its injection into the flue gas stream, to a calcination step by calcining the sorbent precursor to decompose at least a portion of its sodium bicarbonate content and thereby activate the sorbent precursor for reaction with SO_{X}, and (ii) collecting the injected sorbent downstream of the injection point in a solids collection device.

2. The process of claim 1 wherein the SO_{X} comprises a sulfur oxide selected from the group consisting of SO₂ and SO₃ and mixtures thereof

3. The process of claim 1 wherein the sorbent has a mean particle size smaller than about 50 μm.

4. The process of claim 1 wherein the sorbent has a mean particle size smaller than about 40 μm.

5. The process of claim 1 wherein the sorbent precursor is calcined by heating the sorbent precursor to a temperature of about 175° F. to about 500° F.

6. The process of claim 1 wherein the sorbent precursor is calcined by heating the sorbent precursor to a temperature of about 200° F. to about 400° F.

7. The process of claim 1 wherein the sorbent precursor is calcined to decompose at least about 25 wt % of its initial sodium bicarbonate content.

8. The process of claim 1 wherein the sorbent precursor is calcined to decompose at least about 80 wt % of its initial sodium bicarbonate content.

9. The process of claim 1 wherein the calcination step is carried out by contacting the sorbent precursor with combustion gas from burning of natural gas with air.

10. The process of claim 1 wherein the calcination step is carried out by contacting the sorbent precursor with a side stream of hot combustion flue gas.

11. The process of claim 10 wherein the side stream of combustion flue gas comprises combustion flue gas diverted from the hot side or cool side of an economizer or from the hot-side of an air preheater.

12. The process of claim 1 wherein the flue gas stream at the calcined sorbent injection point has a temperature of about 250° F. to about 900° F.

13. The process of claim 1 wherein the calcined sorbent is injected into the flue gas stream downstream of an air preheater into the cool-side flue gas stream.

14. The process of claim 1 wherein the solids collection device is selected from the group consisting of bag filtration devices, electrostatic precipitators, and wet scrubbers.

15. A process for desulfurizing a combustion flue gas stream which comprises (i) injecting a calcined particulate sodium-based sorbent into a combustion flue gas stream containing SO_{X}, the flue gas stream having a temperature of about 200° F. to about 1100° F., to desulfurize the flue gas,
the sorbent being derived from a sorbent precursor selected from the group consisting of trona, sodium sesquicarbonate, nahcolite, sodium bicarbonate, wegscheiderite and combinations of these, and
the sorbent being prepared for injection and reaction with SO_{X}
by milling a coarsely-sized sorbent precursor to provide a milled particulate sorbent precursor having a mean particle size smaller than about 75 μm and
by subjecting the milled sorbent precursor, immediately prior to its injection into the flue gas stream, to a calcination step by calcining the sorbent precursor to decompose at least a portion of its sodium bicarbonate content and thereby activate the sorbent precursor for reaction with So_{X}, and
(ii) collecting the injected sorbent downstream of the injection point in a solids collection device.

16. The process of claim 15 wherein the milled sorbent precursor has a mean particle size smaller than about 50 μm.

17. The process of claim 15 wherein the milled sorbent precursor has a mean particle size smaller than about 40 μm.

18. The process of claim 15 wherein the coarsely-sized sorbent precursor has a mean particle size in the range of about 75 μm to about 2 mm.

19. The process of claim 15 wherein the coarsely-sized sorbent precursor has a mean particle size greater than about 50 μm and the milled sorbent precursor has a mean particle size smaller than about 40 μm.
